(19) United States
(12) Patent Application Publication
(10) Pub. No.: US 2024/0201658 A1
(43) Pub. Date: Jun. 20, 2024

(54) MONITORING SYSTEM AND MONITORING METHOD

(71) Applicant: SHIMADZU CORPORATION, Kyoto (JP)

(72) Inventors: Andy SASAKI, Columbia, MD (US); Timothy LEE, Columbia, MD (US)

(73) Assignee: SHIMADZU CORPORATION, Kyoto (JP)

(21) Appl. No.: 18/287,789

(22) PCT Filed: Mar. 28, 2022
(86) PCT No.: PCT/JP2022/015196

§ 371 Date: Oct. 20, 2023

Related U.S. Application Data
(60) Provisional application No. 63/178,170, filed on Apr. 22, 2021.

(51) Int. Cl. G05B 19/4155; B01J 19/00

(52) U.S. Cl. CPC G05B 19/4155; B01J 19/0006; B01J 2219/00202; B01J 2219/00209; G05B 2219/32287

(57) ABSTRACT

A monitoring system that monitors a reactor for producing a reaction product includes a first controller that controls the reactor, an analyzer that analyzes the reaction product, a second controller that controls the analyzer, and an information transmission device that transmits information between the first controller and the second controller, wherein the information transmission device includes an information receiver that receives information from one controller of the first and second controllers, a converter that converts information received from the information receiver into a format processable by another controller of the first and second controllers, and an information sender that sends information converted by the converter to the other controller.

### TECHNICAL FIELD

The present invention relates to a monitoring system and a monitoring method.

### BACKGROUND ART

In recent years, the Process Analytical Technology (PAT) has been introduced in the oil industry and the chemical industry. With the Process Analytical Technology, a manufacturing process is designed, analyzed and managed by timely measurement of raw materials, substrates in the manufacturing process, and critical quality, performance or characteristics of the manufacturing process. Also in the biotechnology and pharmaceutical industries, introduction of similar Process Analytical Technology is promoted or demanded. With the Process Analytical Technology, continuous inspection and monitoring are performed from a remote place not only after completion of manufacturing but also during manufacturing.

For example, JP 2020-520298 A describes a modular chemical reaction system for executing chemical reaction. The modular chemical reaction system of Patent Document 1 includes an analysis device and further includes a process circuit that monitors or optimizes chemical reaction based on the feedback received from the analysis device or the like.
[Patent Document 1] JP 2020-520298 A

### SUMMARY OF INVENTION

### Technical Problem

For example, in a manufacturing process of a drug, it is desired that information in regard to the quality of a drug being manufactured or the like is supplied at an appropriate time. In this case, a plurality of devices such as a reaction device and an analysis device are required to cooperate with each other.

However, in a case in which a reaction device and an analysis device are manufactured by different manufacturers, it is impossible or difficult for the reaction device and the analysis device to cooperate with each other.

An object of the present invention is to provide a monitoring system including an information transmission device which enables the cooperative operation between a reactor and an analyzer, and a monitoring method.

### Solution to Problem

A monitoring system according to one aspect that monitors a reactor for producing a reaction product, includes a first controller that controls the reactor, an analyzer that analyzes the reaction product, a second controller that controls the analyzer, and an information transmission device that transmits information between the first controller and the second controller, wherein the information transmission device includes an information receiver that receives information from one controller of the first and second controllers, a converter that converts information received from the information receiver into a format processable by another controller of the first and second controllers, and an information sender that sends information converted by the converter to the another controller.

### BRIEF DESCRIPTION OF THE DRAWINGS

FIG. 1 is a block diagram showing the configuration of a monitoring system including an information transmission device according to the present embodiment.

FIG. 2 is a block diagram showing the configuration of the information transmission device of FIG. 1.

FIG. 3 is a block diagram showing the functional configuration of the information transmission device of FIG. 1.

FIG. 4 is a flowchart showing one example of an information transmitting operation executed by the information transmission device of FIG. 3.

FIG. 5 is a flowchart showing the one example of the information transmitting operation executed by the information transmission device of FIG. 3.

FIG. 6 is a flowchart showing the one example of the information transmitting operation executed by the information transmission device of FIG. 3.

### DESCRIPTION OF EMBODIMENTS

An information transmission device, a monitoring system including the information transmission device and an information transmitting method according to one embodiment of the present invention will be described below in detail with reference to the drawings.

### (1) Configuration of Monitoring System

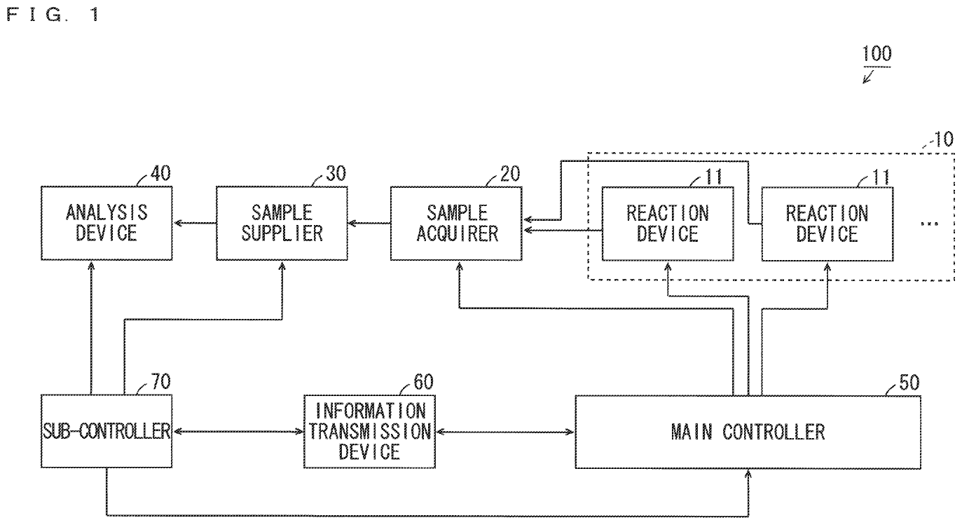

FIG. 1 is a block diagram showing the configuration of the monitoring system including the information transmission device according to the present embodiment. In FIG. 1, the monitoring system 100 includes a reaction system 10, a sample acquirer 20, a sample supplier 30, an analysis device 40, a main controller 50, the information transmission device 60 and a sub-controller 70.

The reaction system 10 includes one or a plurality of reaction devices 11. In the present embodiment, the reaction system 10 includes a plurality of reaction devices 11. In each of the plurality of reaction devices 11, reaction products different from one another are produced. Here, the reaction products include not only final products but also include intermediate products. Further, the reaction products include a compound of a plurality of materials, a mixture of a plurality of materials, etc. For example, a reaction product is a mixture of a plurality of chemical agents.

The sample acquirer 20 acquires part of a reaction product produced in each reaction device 11. This sample acquirer 20 includes a liquid sender and a diluter. The diluter of the sample acquirer 20 dilutes a reaction product acquired from each reaction device 11 with a diluent. Further, the liquid sender of the sample acquirer 20 supplies the diluted reaction product as a sample to the sample supplier 30.

The sample supplier 30 supplies a sample supplied from the sample acquirer 20 to the analysis device 40. The sample supplier 30 is an autosampler, for example. The sample supplier 30 includes a plurality of flow vials corresponding to the plurality of reaction devices 11, for example. A sample supplied from the sample acquirer 20 is introduced into each flow vial. The sample supplier 30 supplies the sample introduced into each flow vial to the analysis device 40.

The analysis device 40 analyzes the sample supplied by the sample supplier 30. For example, the analysis device 40 may be a chromatograph such as a liquid chromatograph, a gas chromatograph or a supercritical fluid chromatograph, may be a mass spectrometer or may be another analysis device that uses an optical system such as infrared light, ultraviolet visible light, atomic absorption or plasma emission. In the present embodiment, the analysis device 40 is a liquid chromatograph.

The main controller 50 controls the operations of the plurality of reaction devices 11 of the reaction system 10 and the sample acquirer 20. The sub-controller 70 controls the operations of the sample supplier 30 and the analysis device 40.

In the present embodiment, the format of information that is processable (readable) by the main controller 50 is different from the format of information that is processable by the sub-controller 70. Specifically, the main controller 50 and the sub-controller 70 are configured to operate according to control programs written in different program languages.

In the present embodiment, the main controller 50 operates according to a first control program written in a first program language. The sub-controller 70 operates according to a second control program written in a second program language. Although the first program language is Phython, for example, and the second program language is C language, for example, the first and second program languages are not limited to these. Hereinafter, the format of information that is processable by the first program is referred to as a first format, and the format of information that is processable by the second program is referred to as a second format.

The main controller 450 includes a CPU (Central Processing Unit), a RAM (Random Access Memory), a ROM (Read Only Memory), an input-output I/F (interface) and a storage device. The first control program is stored in the ROM or the storage device. The CPU controls the operation of each reaction device 11 by executing the first control program stored in the ROM or the storage device on the RAM.

Similarly to the main controller 50, the sub-controller 70 includes a CPU, a RAM, a ROM, an input-output I/F and a storage device. The second control program is stored in the ROM or the storage device. The CPU controls the operation of the analysis device 40 by executing the second control program stored in the ROM or the storage device on the RAM.

The information transmission device 60 transmits information between the main controller 50 and the sub-controller 70. The information includes data, commands, responses and the like. The configuration and operation of the information transmission device 60 will be described below in detail.

### (2) Configuration of Information Transmission Device 60

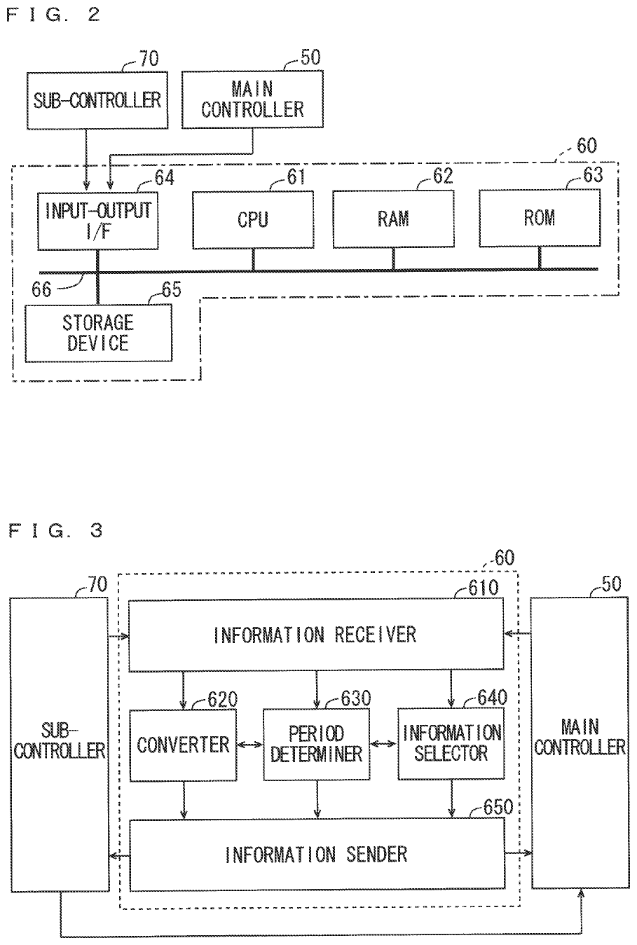

FIG. 2 is a block diagram showing the configuration of the information transmission device 60 of FIG. 1. The information transmission device 60 includes a CPU (Central Processing Unit) 61, a RAM (Random Access Memory) 62, a ROM (Read Only Memory) 63 and an input-output I/F (interface) 64. The CPU 61, the RAM 62, the ROM 63 and the input-output I/F 64 are connected to a bus 66. A storage device 65 is connected to the bus 66. The storage device 65 may be an external storage device provided outside of an analysis control device 1.

The RAM 62 is used as a work area for the CPU 61. A system program is stored in the ROM 63. The storage device 65 includes a storage medium such as a hard disc or a semiconductor memory. The main controller 50 and the sub-controller 70 are connected to the input-output I/F 64.

The storage device 65 stores an information transmission program. The information transmission program is a computer program for execution of an information transmitting operation by the information transmission device 60. The information transmission program may be stored in the ROM 63, another storage device or the like.

When the CPU 61 executes the information transmission program stored in the RAM 63 on the RAM 62, the information transmitting operation is executed by the information transmission device 60 on the main controller 50 and the sub-controller 70 via the input-output I/F 64. The information transmitting operation will be described below.

While the main controller 50, the information transmission device 60 and the sub-controller 70 respectively includes different hardware in the present embodiment, all or part of the main controller 50, the information transmission device 60 and the sub-controller 70 may include common hardware. In this case, a plurality of programs out of the first control program, the second control program and the information transmission program may be stored in a ROM or a RAM of the common hardware. That is, part or all of the main controller 50, the information transmission device 60 and the sub-controller 70 may include a common computer or server.

FIG. 3 is a block diagram showing the functional configuration of the information transmission device 60 of FIG. 1. The information transmission device 60 includes an information receiver 610, a converter 620, a period determiner 630, an information selector 640 and an information sender 650. The information receiver 610 receives information provided from one or both of the main controller 50 and the sub-controller 70.

In the present embodiment, the information receiver 610 receives information in the first format from the main controller 50 and receives information in the second format from the sub-controller 70. The information received from the main controller 50 by the information receiver 610 includes control information for controlling an analysis performed by the analysis device 40. The control information includes analysis conditions of the analysis device 40, an analysis method, an analysis batch, a working status sending request, an error information sending request, a sending request for start and end of an analysis batch and the like.

The analysis conditions of the analysis device 40 include information specifying a sample to be analyzed and a vial in which the sample is to be contained, a point in time at which an analysis is started by the analysis device 40, an analysis period of time, an amount of sample to be supplied to the analysis device 40, a name of sample, information for controlling a pump, information for controlling supply of a mobile phase and the like. The analysis method includes an analysis procedure and an analysis condition. The analysis batch includes an analysis procedure and an analysis condition for continuously performing an analysis in regard to a plurality of samples. The working status of the analysis device 40 is a pressure value of a pump used in the analysis device 40 and a liquid sending amount of a mobile phase, for example. The error information is the information representing whether the analysis device 40 is in an error state during an analysis and the details of the error state. The start and end of an analysis batch are the information representing the start and end of an analysis batch.

Further, the information received from the sub-controller 70 by the information receiver 610 includes production information produced due to an analysis performed by the analysis device 40 and a response to a request. The production information includes an analysis result of the analysis device 40, an analysis state (analysis status), a working status, error information, information representing the start and end of an analysis batch, and the like. The analysis result is analysis data such as a chromatogram or a spectrum.

The converter 620 converts the information in the first format received from the main controller 50 by the information receiver 610 into the information in the second format, and converts the information in the second format received from the sub-controller 70 by the information receiver 610 into the information in the first format. For example, in order to mutually convert the format of the information that is processable in the first program language and the information that is processable in the second program language, a wrapper is used. In a case in which including a value, an analysis result can be processed by both of the first controller 50 and the second controller 70. In this case, the converter 620 does not need to convert the format of the analysis result.

The period determiner 630 determines the transmission period of the specific production information from the sub-controller 70 to the main controller 50 based on the specific control information received from the main controller 40 by the information receiver 610.

For example, the relationship between a sample and an analysis period of time of the analysis device 40 is known based on an analysis condition included in control information. Therefore, the transmission period of a specific analysis state from the sub-controller 70 to the main controller 50 may be determined based on an analysis condition. In this case, in a case in which an analysis period of time is long, a transmission period may be set long. In a case in which an analysis period is short, a transmission period may be set short. This can prevent necessary information from not being sent or unnecessary sending from being performed.

The period determiner 630 may determine the transmission period of control information from the main controller 50 to the main controller 70 based on production information received from the sub-controller 70 by the information receiver 610. For example, the transmission period of an analysis condition from the main controller 50 to the sub-controller 70 may be determined based on the start and end of an analysis batch included in production information received from the sub-controller 70.

The information selector 640 selects production information to be transmitted from the sub-controller 70 to the main controller 50 based on control information received by the information receiver 610. For example, in a case in which an analysis condition included in the control information includes a pressure value of a specific pump, the information selector 640 selects the pressure value of the pump as the production information. Further, in a case in which an analysis condition included in the control information includes a liquid sending amount of a mobile phase, the information selector 640 selects the liquid sending amount of the mobile phase as the production information.

The information selector 640 may select control information to be transmitted from the main controller 50 to the sub-controller 70 based on production information received from the sub-controller 70 by the information receiver 610. For example, a control item of control information transmitted from the main controller 50 to the sub-controller 70 may be selected based on an analysis state included in the production information received from the sub-controller 70.

The information sender 650 sends information in the first format converted by the converter 620 to the main controller 50, and sends information in the second format converted by the converter 620 to the sub-controller 70. In a case in which including a value, an analysis result such as a chromatogram and a spectrum may be directly sent from the sub-controller 70 to the main controller 50.

### (3) Information Transmitting Operation

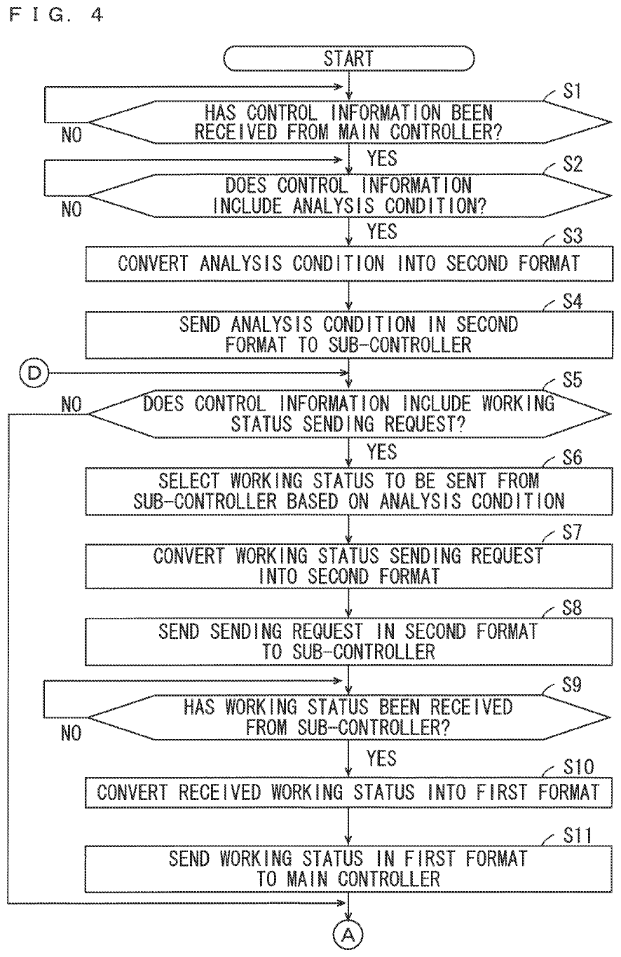

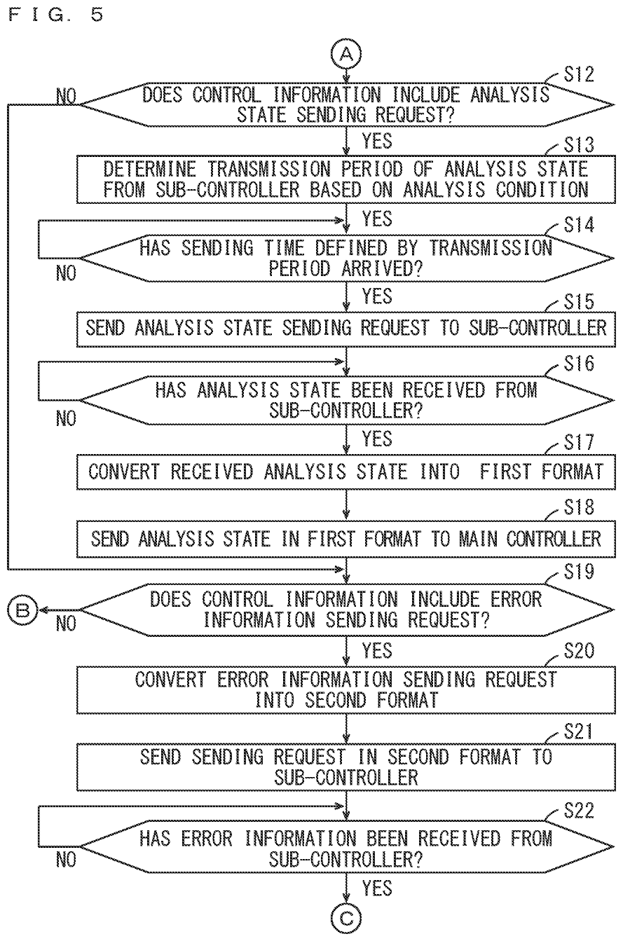

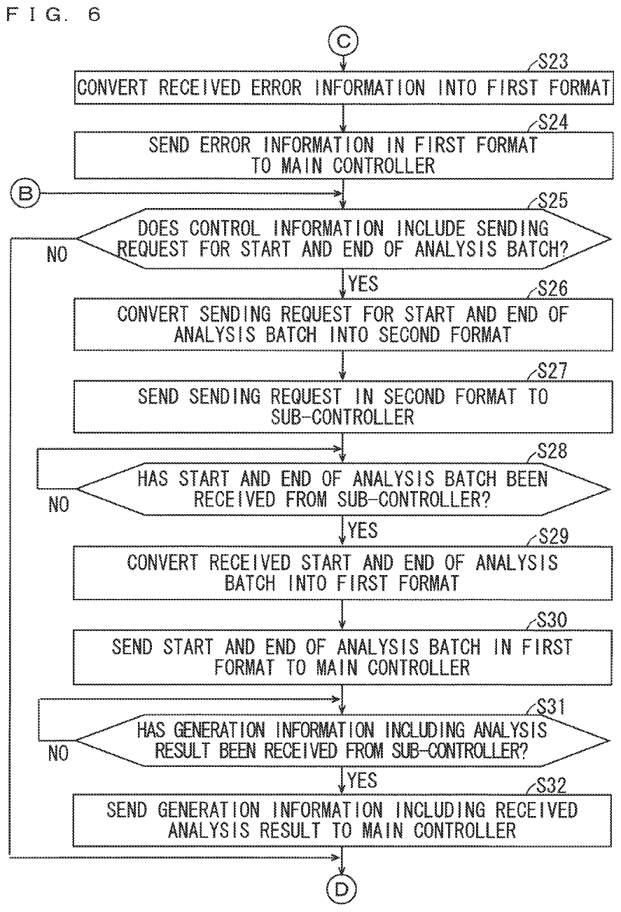

FIGS. 4 to 6 are flowcharts showing one example of an information transmitting operation of the information transmission device 60 of FIG. 3. In the examples of FIGS. 4 to 6, the information transmitting operation in one analysis operation is shown. First, as shown in FIG. 4, the information receiver 610 determines whether control information has been received from the main controller 50 (step S1). The control information has a first format. In a case in which the control information is not received, the information receiver 610 repeats the determination of the step S1.

In a case in which the control information is received, the information receiver 610 determines whether an analysis condition is included in the control information (step S2). Here, in a case in which the control information is an analysis method or an analysis batch, the analysis method or the analysis batch includes an analysis condition. In a case in which an analysis condition is not included in the control information, the information receiver 610 repeats the determination of the step S2. In a case in which an analysis condition is included in the control information, the converter 620 converts the analysis condition received by the information receiver 610 into the second format (step S3). The information sender 650 sends the analysis condition in the second format to the sub-controller 70 (step S4).

Next, the information receiver 610 determines whether a working status sending request is included in the control information (step S5). In a case in which the control information does not include a working status sending request, the information receiver 610 proceeds to the step S12, described below. In a case in which the control information includes a working status sending request, the information selector 640 selects a working status to be sent from the sub-controller 70 based on an analysis condition received by the information receiver 610 (step S6).

For example, in a case in which the analysis condition includes a pressure value of a specific pump, the pressure value of the pump is selected as a working status. On the other hand, in a case in which the analysis condition does not include a pressure value of a specific pump, a pressure value of a pump is not selected as a working status. Further, in a case in which the analysis condition includes a liquid sending amount of a mobile phase, a mobile phase is selected as a working status. On the other hand, in a case in which the analysis condition does not include a sending request for a liquid sending amount of a mobile phase, a liquid sending amount of a mobile phase is not selected as a working status.

The converter 620 converts a working status sending request into the second format (step S7). The information sender 650 sends the working status sending request in the second format to the sub-controller 70 (step S8).

Thereafter, the information receiver 610 determines whether a working status of the analysis device 40 has been received from the sub-controller 70 (step S9). In a case in which not receiving a working status of the analysis device 40 from the sub-controller 70, the information receiver 610 repeats the determination of the step S9. In a case in which the information receiver 610 receives a working status of the analysis device 40 from the sub-controller 70, the converter 620 converts the working status received by the information receiver 610 into the first format (step S10). The information sender 650 sends the working status in the first format to the sub-controller 70 (step S11).

Subsequently, the information receiver 610 determines whether the control information includes an analysis state sending request (step S12). In a case in which the control information does not include an analysis state sending request, the information receiver 610 proceeds to the step S19, described below. In a case in which the control information includes an analysis state sending request, the period determiner 630 determines the transmission period of an analysis state from the sub-controller 70 to the main controller 50 based on an analysis condition received by the information receiver 610 in the steps S1 and S2 (step S13).

The information receiver 610 determines whether the transmission period determined by the period determiner 630 has arrived (step S14). In a case in which the transmission period has not arrived, the information receiver 610 repeats the determination of the step S14. In a case in which the transmission period has arrived, the information sender 650 sends an analysis state sending request (in the second format) to the sub-controller 70 (step S15). The information receiver 610 determines whether an analysis state has been received from the sub-controller 70 (step S16). In a case in which not receiving an analysis state from the sub-controller 70, the information receiver 610 repeats the determination of the step S16.

In a case in which the information receiver 610 has received an analysis state from the sub-controller 70, the converter 620 converts the analysis state received by the information receiver 610 into the first format. The information sender 650 sends the analysis state in the first format to the sub-controller 70 (step S18). Thereafter, when the sending time arrives, the process of the steps S15 to S18 is executed. Thus, the analysis state of the analysis device 40 is sent from the sub-controller 70 to the main controller 50 in the determined transmission period.

Next, the information receiver 610 determines whether an error information sending request is included in the control information (step S19). In a case in which an error information sending request is not included in the control information, the information receiver 610 proceeds to the step S25, described below. In a case in which an error information sending request is included in the control information, the converter 620 converts the error information sending request into the second format (step S20). The information sender 650 sends the error information sending request in the second format to the sub-controller 70 (step S21).

Thereafter, the information receiver 610 determines whether error information has been received from the sub-controller 70 (step S22). In a case in which error information is not received, the information receiver 610 repeats the determination of the step S21. The converter 620 converts error information received from the sub-controller 70 by the information receiver 610 into the first format (step S23). The information sender 650 sends the error information in the first format to the main controller 50 (step S24).

Subsequently, the information receiver 610 determines whether the control information includes a sending request for the start and end of an analysis batch (step S25). In a case in which the control information does not include a sending request for the start and end of an analysis batch, the information receiver 610 returns to the step S5. In a case in which the control information includes a sending request for the start and end of an analysis batch, the converter 620 converts the sending request for the start and end of an analysis batch into the second format (step S26). The information sender 650 sends the sending request for the start and end of an analysis batch in the second format to the sub-controller 70 (step S27).

Thereafter, the information receiver 610 determines whether the start and end of an analysis batch are received from the sub-controller 70 (step S28). In a case in which the information receiver 610 has not received a sending request for the start and end of an analysis batch, the information receiver 111 repeats the determination of the step S28. In a case in which the information receiver 610 has received the start and end of an analysis batch, the converter 620 converts the start and end of an analysis batch into the first format (step S29). The information sender 650 sends the start and end of an analysis batch in the first format to the main controller 50 (step S30).

Next, the information receiver 610 determines whether production information including an analysis result (analysis data) has been received from the sub-controller 70 (step S31). In a case in which production information including an analysis result is not received, the information receiver 610 repeats the determination of the step S31. In a case in which the information receiver 610 receives production information including an analysis result, the information sender 650 sends the production information including an analysis result to the main controller 50 (step S32). In this case, because being represented by a value, an analysis result such as a chromatogram is processable (readable) in both of the first program language and the second program language. Therefore, the format conversion is not performed by the converter 620.

### (4) Effects of Embodiments

According to the information transmission device 60 of the monitoring system 100 according to the present embodiment, control information received from the main controller 50 is converted into a format that is processable by the second control program, and production information received from the sub-controller 70 is converted into a format that is processable by the first control program. Thus, even in a case in which the first format of control information processable in the first program language is different from the second format of production information processable in the second program language, the main controller 50 can control the reaction device 11 based on the production information transmitted from the sub-controller 70, and the sub-controller 70 can control the reaction device 11 based on the control information transmitted from the main controller 50. As a result, the cooperative operation between the reaction device 11 and the analysis device 40 is enabled.

Further, because the transmission period of production information from the sub-controller 70 to the main controller 50 is determined based on control information received from the main controller 50, it is possible to reduce the communication load between the main controller 50 and the sub-controller 70. Similarly, because the transmission period of control information from the main controller 50 to the sub-controller 70 is determined based on production information received from the sub-controller 70, it is possible to reduce the communication load between the main controller 50 and the sub-controller 70.

Further, because production information transmitted from the sub-controller 70 to the main controller 50 is selected based on control information received from the main controller 50, it is possible to suppress an increase in communication load between the main controller 50 and the sub-controller 70 caused by unnecessary transmission of information. Similarly, because control information transmitted from the main controller 50 to the sub-controller 70 is selected based on production information received from the sub-controller 70, it is possible to suppress an increase in communication load between the main controller 50 and the sub-controller 70 caused by unnecessary transmission of information.

Further, with the monitoring system 100 according to the present embodiment, the reaction device 11 is controlled by the main controller 50, and the analysis device 40 is controlled by the sub-controller 70. Further, even in a case in which the main controller 50 and the sub-controller 70 are manufactured by different companies, the information transmission device 60 enables the cooperative operation between the main controller 50 and the sub-controller 70. Thus, a reaction product produced by the reaction device 11 can be analyzed by the analysis device 40 at an appropriate time. Therefore, it is possible to monitor the reaction product produced by the reaction device 11 based on an analysis performed by the analysis device 40.

### (5) Other Embodiments

In the above-mentioned embodiment, the main controller 50 controls the plurality of reaction devices 11 and the sample acquirer 20, and the sub-controller 70 controls the sample supplier 30 and the analysis device 40. However, the present invention is not limited to this. For example, the main controller 50 may control the plurality of reaction devices 11, the sample acquirer 20 and the sample supplier 30, and the sub-controller 70 may control the analysis device 40. The main controller 50 may control the reaction device 11 of the reaction system 10 and a reaction device of another reaction system, and the sub-controller 60 may control the analysis device 40 and another analysis device.

### (6) Correspondences Between Constituent Elements in Claims and Parts in Preferred Embodiments

In the following paragraphs, non-limiting examples of correspondences between various elements recited in the claims below and those described above with respect to various preferred embodiments of the present disclosure are explained. In the above-mentioned embodiment, the reaction device 11 is an example of a reactor, the analysis device 40 is an example of an analyzer, the main controller 50 is an example of a first controller and the sub-controller 70 is an example of a second controller.

### (7) Aspects

It will be appreciated by those skilled in the art that the exemplary embodiments described above are illustrative of the following aspects.

(Item 1) A monitoring system according to one aspect that monitors a reactor for producing a reaction product includes a first controller that controls the reactor, an analyzer that analyzes the reaction product, a second controller that controls the analyzer, and an information transmission device that transmits information between the first controller and the second controller, wherein the information transmission device includes an information receiver that receives information from one controller of the first and second controllers, a converter that converts information received from the information receiver into a format processable by another controller of the first and second controllers, and an information sender that sends information converted by the converter to the another controller.

With the monitoring system according to one embodiment, information sent from one of the first and second controllers is received by the information receiver. The received information is converted into a form readable by the other one of the first and second controllers. The converted information is sent to the other controller by the information sender. Thus, even in a case in which the format of information processed by the first controller is different from the format of information processed by the second controller, the first controller can process information sent by the second controller, and the second controller can process information sent by the first controller. Thus, the first controller can control the reactor based on information transmitted from the second controller, and the second controller can control the reactor based on information transmitted from the first controller. As a result, the cooperative operation between the reactor and the analyzer is enabled.

(Item 2) The information transmission device according to item 1, wherein the first controller may be configured to be operated by a first control program written in a first program language, the second controller may be configured to be operated by a second control program written in a second program language, and the converter may convert information received from the first controller into a format processable by the second control program, and converts information received from the second controller into a format processable by the first control program.

With the monitoring system according to item 2, information received from the first controller is converted into a format processable by the second control program, and information received from the second controller is converted into a format processable by the first control program. Thus, even in a case in which the format of information processable in the first program language is different from the format of information processable in the second program language, the first controller can control the reactor based on information transmitted from the second controller, and the second controller can control the reactor based on information transmitted from the first controller.

(Item 3) The information transmission device according to item 1 or 2, wherein the information receiver may receive control information in regard to control of the analyzer as the information from the first controller, the converter may convert the control information received by the information receiver into a format processable by the second controller, and the information transmitter may transmit the control information converted by the converter to the second controller.

With the monitoring system according to item 3, the second controller can control the analysis device based on control information provided from the first controller. Thus, the first and second controllers can operate the analysis device in cooperation with the control of the reaction device.

(Item 4) The information transmission device according to items 1 to 3, wherein the information receiver may receive production information that is produced due to an operation of the analyzer as the information from the second controller, the converter may convert the production information received by the information receiver into a format processable by the first controller, and the information transmitter may transmit the production information converted by the converter to the first controller.

With the monitoring system according to item 4, the first controller can control the reaction device based on production information provided from the second controller. Thus, the first controller can control the reaction device based on production information of the analysis device.

(Item 5) The information transmission device according to any one of items 1 to 4, may further include a period determiner that determines a transmission period of information from the another controller to the one controller based on information received from the one controller by the information receiver.

With the monitoring system according to item 5, it is possible to reduce the communication load between the first controller and the second controller.

(Item 6) The information transmission device according to any one of items 1 to 5, may further include an information selector that selects information to be transmitted from the another controller to the one controller based on information received from the one controller by the information receiver.

With the monitoring system according to item 6, it is possible to reduce the communication load between the first controller and the second controller.

(Item 7) The received information according to item 5 may include a period of time during which the reaction product is analyzed by the analyzer.

With the monitoring system according to item 7, it is possible to reduce the communication load between the first controller and the second controller.

(Item 8) A monitoring method according to another aspect of monitoring a reactor that produces a reaction product includes the step of transmitting information between a first controller that controls a reactor for producing a reaction product and a second controller that controls an analyzer for analyzing the reaction product, wherein the step of transmitting includes receiving information from one controller of the first and second controllers, converting information received in the receiving into a format readable by another controller of the first and second controllers, and transmitting information converted in the converting to the another controller.

With the information transmission method according to another aspect, information sent from one of the first and second controllers is received by the information receiver. The received information is converted into a form readable by the other one of the first and second controllers. The converted information is sent to the other controller by the information sender. Thus, even in a case in which the format of information processed by the first controller is different from the format of information processed by the second controller, the first controller can process information sent by the second controller, and the second controller can process information sent by the first controller. Thus, the first controller can control the reactor based on information transmitted from the second controller, and the second controller can control the reactor based on information transmitted from the first controller. As a result, the cooperative operation between the reaction device and the analysis device is enabled.

1. A monitoring system that monitors a reactor for producing a reaction product, comprising:
a first controller that controls the reactor;
an analyzer that analyzes the reaction product;
a second controller that controls the analyzer; and
an information transmission device that transmits information between the first controller and the second controller, wherein
the information transmission device includes
an information receiver that receives information from one controller of the first and second controllers,
a converter that converts information received from the information receiver into a format processable by another controller of the first and second controllers, and
an information sender that sends information converted by the converter to the another controller.

2. The monitoring system according to claim 1, wherein
the first controller is configured to be operated by a first control program written in a first program language,
the second controller is configured to be operated by a second control program written in a second program language, and
the converter converts information received from the first controller into a format processable by the second control program, and converts information received from the second controller into a format processable by the first control program.

3. The monitoring system according to claim 1, wherein
the information receiver receives control information in regard to control of the analyzer as the information from the first controller,
the converter converts the control information received by the information receiver into a format processable by the second controller, and
the information transmitter transmits the control information converted by the converter to the second controller.

4. The monitoring system according to claim 1, wherein
the information receiver receives production information that is produced due to an operation of the analyzer as the information from the second controller,
the converter converts the production information received by the information receiver into a format processable by the first controller, and
the information transmitter transmits the production information converted by the converter to the first controller.

5. The monitoring system according to claim 1, wherein
the information transmission device further includes a period determiner that determines a transmission period of information from the another controller to the one controller based on information received from the one controller by the information receiver.

6. The monitoring system according to claim 1, wherein
the information transmission device further includes an information selector that selects information to be transmitted from the another controller to the one controller based on information received from the one controller by the information receiver.

7. The monitoring system according to claim 5, wherein
the received information includes a period of time during which the reaction product is analyzed by the analyzer.

8. A monitoring method of monitoring a reactor that produces a reaction product, including the step of:
transmitting information between a first controller that controls a reactor for producing a reaction product and a second controller that controls an analyzer for analyzing the reaction product, wherein
the step of transmitting includes
receiving information from one controller of the first and second controllers,
converting information received in the receiving into a format readable by another controller of the first and second controllers, and
transmitting information converted in the converting to the another controller.
